(19) United States
(12) Patent Application Publication
(10) Pub. No.: US 2010/0070560 A1
(43) Pub. Date: Mar. 18, 2010

(54) Implementing a Java Server in a Multiprocessor Environment

(76) Inventors: J. C. Hale, Rancho Santa Margarita, CA (US); Michael James Irving, Mission Viejo, CA (US); Thomas A. Salter, Hatfield, PA (US); Daniel P. Meyer, Downingtown, PA (US); Diana L. Montenegro, Mission Viejo, CA (US)

Correspondence Address: UNISYS CORPORATION, UNISYS WAY, MAIL STATION: E8-114, BLUE BELL, PA, 19424, US

(21) Appl. No.: 12/209,509

(22) Filed: Sep. 12, 2008

(51) Int. Cl. G06F 15/16; G06F 15/173

(52) U.S. Cl. 709/203; 709/226

(57) ABSTRACT

A method for utilizing multiple servers begins by selecting a program to be run on one of a plurality of servers and selecting one server to run the program. A virtual machine is instantiated on the selected server and the program is run on the virtual machine. A method for utilizing multiple processors begins by initializing a virtual machine on a server and running a program on the virtual machine. Task requests are sent from the program to a control process on a host environment. The control process initializes a worker thread for each task request. Each worker thread is run on a different processor on the host environment. In one embodiment, the server is a Java server and the virtual machine is a Java virtual machine.

### FIELD OF INVENTION

The present invention is related to computer systems with multiple processors, and in particular, to implementing a Java server on such systems.

### BACKGROUND

An application written in the Java programming language is designed to be executed on a Java Virtual Machine (JVM). There are different JVMs for different computer operating systems, such as Microsoft Windows, Mac OS, Linux, and Master Control Program (MCP).

In an MCP environment, the MCP operating system controls all job initiation and termination, data access (file input/output (IO) and management), and network access (sockets). Applications are deployed to the MCP file system and sockets are opened from the MCP environment. Java command parameters are entered on the MCP to initiate a “Java proxy” on the MCP. In this sense, a proxy is a software agent that performs a function or operation on behalf of another application or system while hiding the details involved. In this case, the other application is the JVM, which is subsequently initiated on a Java server. The command parameters entered on the MCP are passed to the JVM. Depending on the implementation, the Java server may be running on a specialized processor (e.g., a Java processor) or on a different operating system (e.g., a Windows system).

### SUMMARY

The MCP file system is used for all data and user Java programs. The Windows file system is used for temporary files or for fixed content, such as Windows font files, Java archive (JAR) files, and files to support the execution environment.

One type of JVM is an “eMode JVM,” which supports the ALGOL programming language and its extensions. In the eMode JVM, a getFileSystem( ) Java native method is used to create the MCPFileSystem in the Java Runtime Environment (JRE). The MCPFileSystem is a modified version of the WinNTFileSystem that supports a dual MCP/Windows file system environment, allowing directory management functions to apply to either the MCP file system or the Windows file system. A modified version of the standard C Runtime Library is used to support the dual file system, allowing calls to MCP or to Windows depending on the target file name.

The Windows environment on which the JVM is actually run is integrated with the MCP environment. In particular, files, sockets, native functions (i.e., Java Native Interface (JNI)), and other functions are supported by software running in both the Windows environment and the MCP environment.

For file IO and file management functions, the JVM uses the underlying C/C++ functions, e.g., open, read, and printf. To avoid extensive JVM patching, the underlying C Runtime library is modified to call the appropriate OS environment to allow JVM IO to function with minor modifications.

In a multiprocessor setting, either the Java server may have multiple processors (or there may be multiple Java servers, each running on its own processor), or the host environment may have multiple processors in which each process running on the host environment uses a different processor.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIG. 1 is a block diagram showing a construction of a host environment interacting with a Java server environment;

FIG. 2 is a flowchart showing the operation of the environment shown in FIG. 1;

FIG. 3 is a flowchart showing the operation of a worker thread;

FIG. 4 is a block diagram of a system including multiple Java servers; and

FIG. 5 is a block diagram of a system in which the host environment has multiple processors.

### DETAILED DESCRIPTION

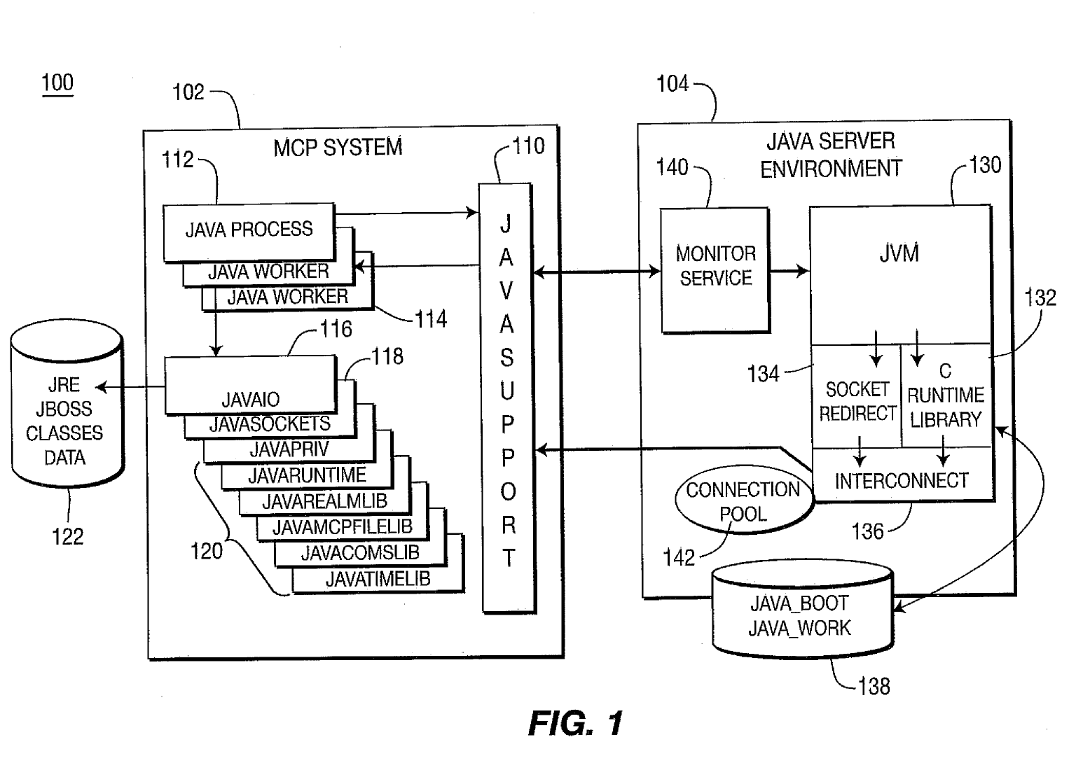

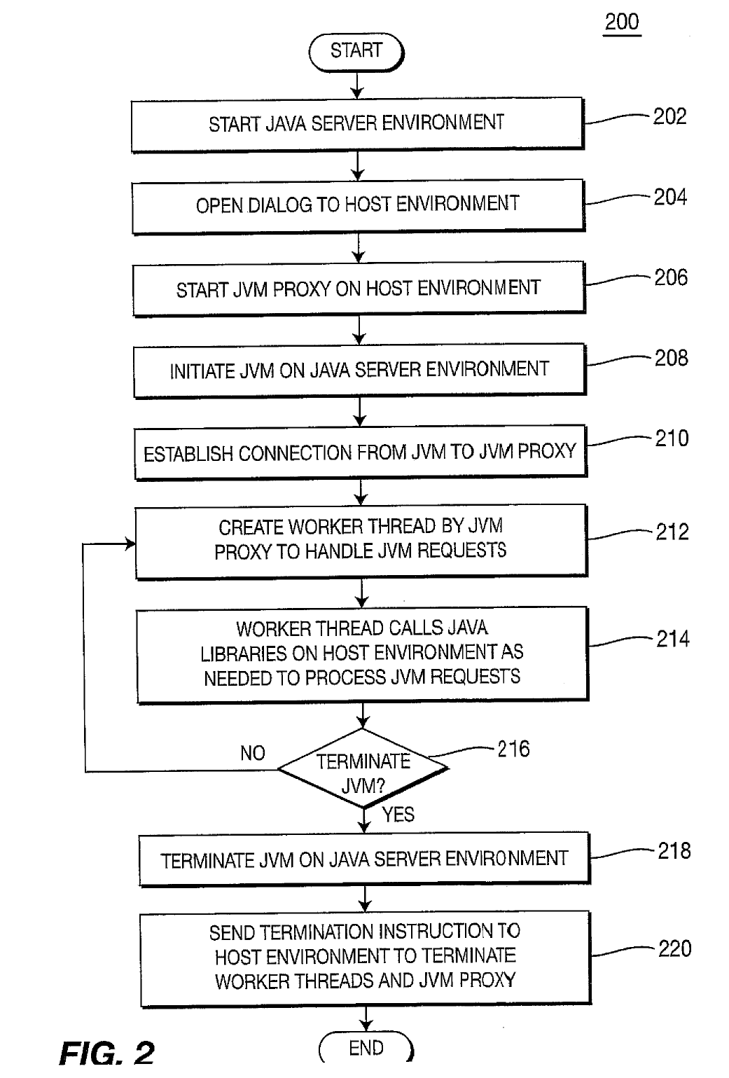

FIG. 1 is a block diagram of a system 100 showing a host environment 102 interacting with a Java server environment 104. The host environment 102 shown in FIG. 1 is an MCP system. The MCP system is exemplary, and the principles of the present invention are applicable to any host environment running any operating system. FIG. 2 is a flowchart of a method 200 showing the operation of the system 100. The operation of the system 100 will be described in conjunction with FIGS. 1 and 2 simultaneously.

The host environment 102 includes a Java support library 110, a Java process 112, a plurality of Java worker threads 114, a Java IO library 116, a Java sockets library 118, a plurality of other Java support processes 120, and a data storage 122. The Java server environment 104 includes a JVM 130, a C runtime library 132, a socket redirect library 134, an interconnect library 136, a data storage 138, a monitor service process 140, and a connection pool 142.

In operation, once the Java server environment 104 is started (step 202), the monitor service 140 attempts to communicate with the Java support library 110 to control the Java server environment 104. Once the Java support library 110 is initiated, it offers an open connection, which allows the monitor service 140 to establish a control dialog (step 204). After the control dialog is successfully created, Java applications can be executed.

To start a Java application, the Java process 112 is run on the host environment 102 (step 206). The Java process 112 is the host environment's “proxy” for the JVM 130. The Java process 112 links to the Java support library 110 and starts establishing a session. The Java support library 110 sends a message to the monitor service 140 through the control dialog to start the session and initiate the JVM 130. As part of this communication, the Java command parameters are passed from the Java process 112 to the monitor service 140. Upon successfully establishing the session, the monitor service 140 initiates the JVM 130 on the Java server 104 (step 208).

The JVM's first step is to initialize the C Runtime Library (CRT) 132. In an MCP environment, the C Runtime Library is a modified version of the Microsoft Visual C Runtime Library, MSVCRT. The CRT 132 contains the low level functions for file open, read, write, close, etc. After initializing its internal file management tables, the CRT 132 establishes a connection back to the host environment 102 through the interconnect library 136 (step 210). The interconnect library 136 provides a marshaling mechanism for converting Intel data into eMode data. The Intel data is in a different format than the eMode data, and needs to be converted via the marshaling mechanism to be usable in both environments.

The CRT 132 is modified to redirect all IO calls to the host environment 102, so that all of the IO is performed in the host environment 102. The Java applications are installed in the host environment 102, and by redirecting the IO to the host environment 102, file management advantages (such as more secure applications) are gained. This allows the Java server environment 104 to be isolated, because all the files and all the sockets (anything that is an external view) are represented on the host environment 102. Naming conventions are provided to simplify the redirection via a JAVA_BOOT directory, so some files can reside on the Windows side and eliminate having to go back and forth to the host environment 102 for the files.

For example, MCP files are identified by the MCP POSIX (Portable Operating System Interface) naming convention, e.g., /-/J2EE/DIR/JRE/LIB/ . . . . A Java application, however, can specify a filename by its relative path name, e.g., RT.JAR, prior to performing a low-level IO call to the JVM file system routines to establish the fully normalized file name.

The initial connection from the CRT 132 through the interconnect library 136 causes the Java support library 110 to instruct the Java process 112 to create a worker thread 114 (step 212). The initial connection from the CRT 132 is used to retrieve various system information, such the initiating user's USERCODE (user ID) and the location of the data storage 122 containing the JRE and the current directory setting. It also enables the Java IO support library 116 to build its file management tables, which are used to support the IO functions in the host environment 102.

A worker thread 114 is initiated by the Java process 112 when required by the JVM 130 and is invoked using standard MCP IPC (inter-process communication). The worker thread 114 is passed an integer which identifies the worker thread and is used to create a unique name for the thread's communication path. A worker thread 114 waits for a message and calls a JVM support library 116-120 to service the request.

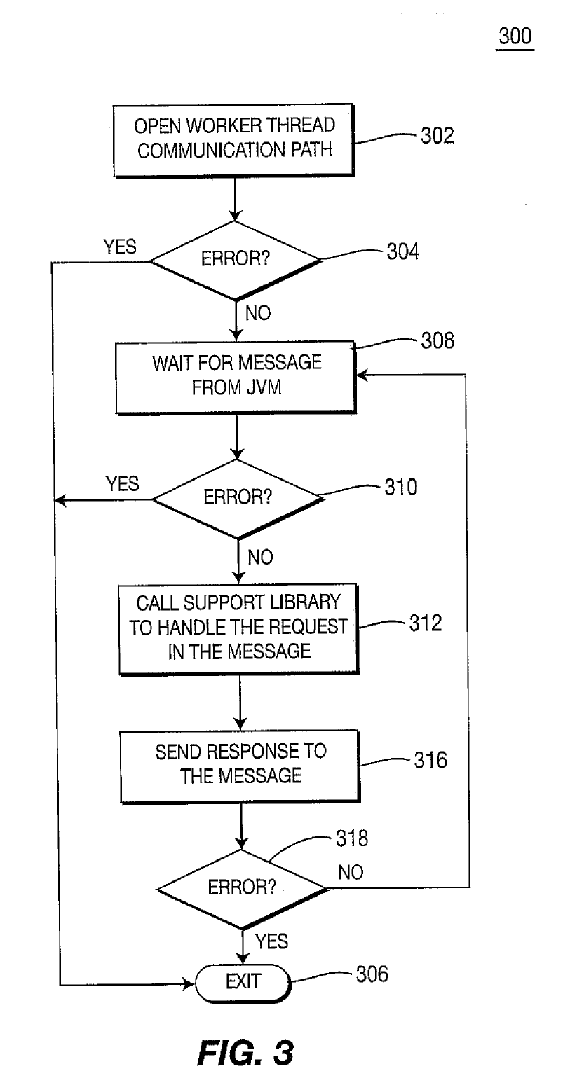

FIG. 3 is a flowchart of a method 300 showing the operation of a worker thread 114. Once created, the worker thread 114 opens a communication path via the Java support library 110 and the interconnect 136 to the JVM 130 (step 302). If there is an error in opening the communication path (step 304), the worker thread exits (step 306). After opening the communication path, the worker thread 114 waits for a message from the JVM 130 (step 308). If the worker thread encounters an error while waiting for a message (step 310), the worker thread exits (step 306). When the worker thread 114 receives a message, it calls the appropriate support library 116-120 to handle the request contained in the message (step 312). If there is an error in calling the support library, the worker thread returns an error response to the JVM (step 316). The worker thread 114 receives a response from the called library and sends the response to the message from the JVM 130 that sent the request (step 316). If there are no errors, the worker thread 114 waits for additional messages from the JVM 130 (step 308) as described above.

Referring back to FIGS. 1 and 2, depending on the request, the worker thread 114 calls a library 116-120 to process the request (step 214). In the system information example, the worker thread 114 calls the Java IO library 116, which handles all the file 10 and file management requests in the host environment 102. The Java IO library 116 gathers the requested information and returns a response to the Java support library 110 through the worker thread 114. The Java support library 110 sends the response to the interconnect library 136, where the data is marshaled from eMode format into Intel format. The response is returned to the CRT 132, which forwards the response to the JVM 130.

As the JVM 130 continues to initialize, it opens various files, such as the MCPLocales file, located in the JRE in the data storage 122 on the host environment 102. Requests to open files on the host environment 102 are routed through the interconnect library 136, through the Java support library 110, to a worker thread 114, and to the Java IO library 116. The Java IO library 116 performs the requested service and returns the response.

For performance reasons, some files are located on the Java server 104, including the RT.JAR and TOOLS.JAR files. The location of these files is specified by the reserved family name JAVA_BOOT (on the data storage 138). Using the JAVA_BOOT directory permits various Java Archive (JAR) files, such as the TOOLS.JAR file, to be identified in a current path parameter using the host environment's naming conventions. The JAVA_BOOT directory is a JRE directory that is read-only from Java applications. The JAVA_BOOT area is defined as the entire directory tree under the location pointed to by the registry value ImagePath for the currently executing JVM. To access files in the JAVA_BOOT area, a Java program uses a path that starts with /-/JAVA_BOOT. The JVM file system implementation substitutes the Windows Java home directory for /-/JAVA_BOOT in the path name. For example, to include the TOOLS.JAR file in a class path, the reference would be: /-/JAVA_BOOT/lib/tools.jar.

Another special directory on the Java server 104 is the JAVA_WORK directory, which is mapped to a directory on the Java server 104 in such a way that each host environment user has a separate work area and cannot access any other user's work areas. In one implementation, the JAVA_WORK directory is mapped based on the user's running USERCODE. For security reasons, each host environment user has a different subdirectory under the JAVA_WORK directory. In this implementation, it is not possible for a Java program running under one user ID to access a Windows file created by a Java program running under a different user ID.

To access files in the JAVA_WORK area, a Java program uses a path that starts with /-/JAVA_WORK. The JVM file system implementation substitutes the Windows work area parent directory, followed by a file name separator character (/), followed by the host environment user name, for /-/JAVA_WORK in the path name. For example, assume that the JAVA_WORK registry value contains the value E:\JavaWorkArea. A Java program run by user JBOSSUSER may reference the path /-/JAVA_WORK/tmp/deployfile. This path accesses the Windows file E:\JavaWorkArea\JBOSSUSER\tmp\deployfile.

The user's view of the disk areas on the Java server is restricted to the JAVA_BOOT and JAVA_WORK directories. As an example, in JBoss (a Java-based application server), the user can set the working directory to the JAVA_WORK directory. This places the workload onto the Windows side, so that back and forth access to the host environment 102 is not needed. Reducing the cross-environment access for file IO also creates a performance benefit by speeding up certain IO operations of the Java program. A further performance benefit can be gained by placing transaction and log services on the Windows side, thereby further reducing host environment access.

As the JVM 130 continues its initialization process, a socket is opened by calling the socket redirect library 134, which is a substitute for the standard WinSock library. The socket requests are routed through the interconnect library 136, like file requests to a worker thread 114, which in turn calls the Java sockets library 118 on the host environment 102. This library call invokes a link to a socket support library on MCP for the actual socket handling. Because requests for IO and socket functions can happen asynchronously, the interconnect library 136 maintains a connection pool 142 on the Java server 104. There is a one-to-one correlation between a connection and a worker thread 114, but subsequent requests to read a file, for example, do not necessarily go to the same connection and worker thread 114.

As the Java application continues its execution, additional requests can be made of host environment 102 resources. In an MCP implementation, several different libraries 122 have been created, including JAVAPRIV, JAVARUNTIME, JAVAREALMLIB, JAVAMCPFILELIB, JAVACOMSLIB, and JAVATIMELIB.

Access to the host environment 102 is based on the privileges associated with the user (in MCP, this is the user's initiating USERCODE). The monitor service 140 runs on the Java server 104 as a global service and all JVMs are initiated with that same global user identifier. All requests for MCP resources are handled by the initiating Java process 112 through the Java support library 110 connection manager and the worker threads 114.

Upon termination of the JVM 130 (steps 216 and 218), the monitor service 140 sends the JVM's exit code to the Java support library 110, which instructs the Java process 112 and all worker threads 114 to terminate (step 220). When the Java process 112 terminates, it returns the exit code to the MCP OS, which inserts it into the task's TASKVALUE.

Runtime Support

MCP runtime functions are accessed by sending messages to the MCP OS. The JVM 130 calls a function in an interface DLL to access the MCP. This interface DLL creates a message to handle the function, converting any data as needed. The message is sent by calling a function in a communication DLL, which maintains a list of available worker threads 114 that handle requests. If no worker threads 114 are available, the DLL sends a message to the Java process 112 identified by its dialog ID to request a new worker thread 114. When a worker thread 114 is available, the DLL sends the function request message to that worker thread 114.

Termination

The Java program may terminate in one of three ways: normal termination, forced termination, or fault termination.

Normal termination occurs when the Java program terminates without an exception. It may have an error, but not one that causes an abnormal termination. Before normal termination, the JVM 130 sends a terminate message containing any exit codes for the process to the Java process 112. It then closes the communication channel and exits.

When a worker thread 114 receives the terminate message, it calls a function in the Java support library 110 to process the message. This function saves any exit codes and changes its state to terminating. When the communication channel closes, the Java process 112 terminates with the specified exit code. When the Java process 112 terminates, the Java support library 110 frees all resources assigned to that instance of the Java process 112.

Forced termination occurs when the Java process 112 is terminated unexpectedly, e.g., with a DS (discontinue) command from the MCP OS. Terminating the Java process 112 closes the communication channel. The JVM 130 terminates when the channel is closed.

Fault termination occurs when the JVM 130 terminates unexpectedly. The Java monitor service 140 tracks the state of the JVM 130. When the JVM 130 terminates unexpectedly, the monitor service 140 sends an abort message to the Java support library 110 containing error information on how the JVM 130 terminated.

The Java support library 110 receives the abort message and saves the error information. The Java process 112 calls a function to retrieve this information. If the function is called before the message is received, the function waits a reasonable amount of time to receive that information before returning.

When the communication channel closes without receiving a terminate message, the Java process 112 calls the function in the Java support library 110 to retrieve the error information. Upon return from the function, the Java process 112 terminates and displays the error information.

Java Monitor Service

The state of a Java server environment 104 and its jobs (i.e., JVMs) may be monitored through the Java monitor service 140, which runs on the Java server 104 (Windows, for example) to handle Java support. The monitor service 140 receives a message on its port, deciphers the message, and performs the appropriate action. It may retrieve information from the Windows OS, from a configuration database, or from a running JVM 130. The monitor service 140 communicates management information with the host environment 102 and logs relevant events in the Windows application log.

The monitor service 140 automatically begins when the Java server 104 starts. After initializing, the monitor service 140 attempts to connect to the Java support library 110 on the host environment 102 and logs the result of this attempt. If the attempt fails, the monitor service 140 periodically retries the connection (without logging) until successful. Once successful, the monitor service 140 sends a connection message to the host environment 102. This message contains the Java server number and the dialog number.

Once the connection is established, the monitor service 140 reads its control dialog for management messages, sending responses as appropriate. These management messages include:
Initiate—This message initiates the execution of a JVM 130. The monitor service 140 uses the information in the message to create a process to run the JVM 130. It sends an InitiateAck response once the JVM 130 has started. The monitor service 140 waits for the JVM 130 to complete and examines the result. If the JVM 130 terminates abnormally, it sends an abort message to the host environment 102.
Status—This message requests the monitor service 140 to send configuration information and system status information.
Terminate JVM—This message requests the monitor service 140 to terminate a JVM 130.
Dump—This message requests the monitor service 140 to cause the JVM 130 to perform a memory dump.
Job Info—This message requests the monitor service 140 to send detailed JVM process information.

The monitor service 140 may also make requests of the Java support library 110 or provide unsolicited status information to the Java support library 110. These management messages include:
JVM Terminated—This message tells the Java support library 110 that a JVM 130 has terminated.
Status Request—This message is used as a “heartbeat” to monitor the connection to the host environment 102. The lack of a response or an error response indicates that the connection has been lost. This message is also used to exchange time synchronization messages with the host environment 102. This allows the Java server 104 to maintain the same system time as the host environment 102.

Java Support Library

The Java support library 110 runs on the host environment 102 to handle Java function management. Under MCP, this is a CONTROL library that starts during MCP initialization. Once initialized, the Java support library 110 listens on its port for management messages from the monitor service 140, sending responses as appropriate. Messages handled by the Java support library 110 include:
Status Request—This message contains the configuration information and system status of a Java server 104. The Java support library 110 updates its information with the information in the status request message and records the time the message is received. If a status request message is not received from an overdue Java server 104, the Java support library 110 marks the Java server 104 as down and stops scheduling jobs on that Java server.
JVM Terminated—This message is received when a JVM 130 terminates abnormally. The Java support library 110 records any error information returned in the message for later retrieval by the initiating program.

The Java support library 110 also provides functions to interact with the Java process 112 and the worker threads 114, including:
Initiate—This function is called by the Java process 112 to initiate a JVM 130. The Java support library 110 examines its list of Java servers 104 and assigns a server to perform the job. The Java servers 104 may be assigned using one or more methods: round-robin, least-busy, or user-assigned. The Initiate message is built and sent to the Java server 104. The Java support library 110 waits a reasonable amount of time to receive an InitiateAck response. If the response is not received, or if it returns with an error, the function returns an unsuccessful response. If the response returns OK, the function returns the socket number with a successful response.
Terminate—This function is called when a Java process 112 is terminating. The Java support library 110 marks the corresponding JVM 130 as terminating and sends a Terminate JVM message to the monitor service 140.
Aborted—This function is called when the communication channel to the worker threads 114 is closed without receiving a terminate message. The Java support library 110 marks the corresponding JVM 130 as aborting. If any error information is recorded with the process, it is returned. If not, the library 110 waits a reasonable amount of time to receive the abort message from the Java server 104. If the abort message is received, the function returns the error information. If it does not receive the abort message, the function returns with an unsuccessful response.

C Runtime Library

The C Runtime Library (CRT) exports a full set of file IO functions that can operate on either the Windows file system or the MCP file system. The file system decision is based on the full path name passed to an open function and the subsequent file descriptor value.

The CRT uses an internal table to manage and track file descriptors. When a file is opened, an entry is added to the internal table, using the table index as the file descriptor returned to the application. The actual file descriptor is stored in the table along with some additional file information obtained from the OS. An indicator is added to the table to identify the OS where that file exists. In this way, the CRT can make the appropriate calls to MCP to handle the IO requests. File descriptors 0, 1, and 2 are reserved for STDIN, STDOUT and STDERR and need not be opened before use; they are automatically mapped to the MCP environment.

Windows Interconnect DLL

Service requests from the JVM 130 are intercepted and handled by the MCP OS. The Windows interconnect DLL 136 is invoked to format the parameters into a message to send to the MCP OS. This DLL has an entry point function (EPF) for every service that can be invoked. The EPF converts its parameters into eMode formats and stores them into a message. Knowledge of the message format for each service request is shared between the EPF and the corresponding function in the Java support libraries 116-120 within the MCP environment 102. The EPF formats the results into Intel format and returns them to the caller.

Two functions are provided in the interconnect DLL 136 to manage the communication paths for worker threads 114. The first function selects an available communication path and a worker thread 114 to send the message. This routine maintains a list of available paths. It selects one path, removes it from the available list, and assigns it to this function call. If no communication path is available, the function sends a message to the Java process 112 to create another communication path. The second function releases an in-use path for reassignment by placing it in the available list. The EPF uses these two functions to obtain a path to a worker thread 114. The communication paths and the corresponding worker threads 114 are closed and destroyed when they are no longer needed.

Multiple Java Server Environment

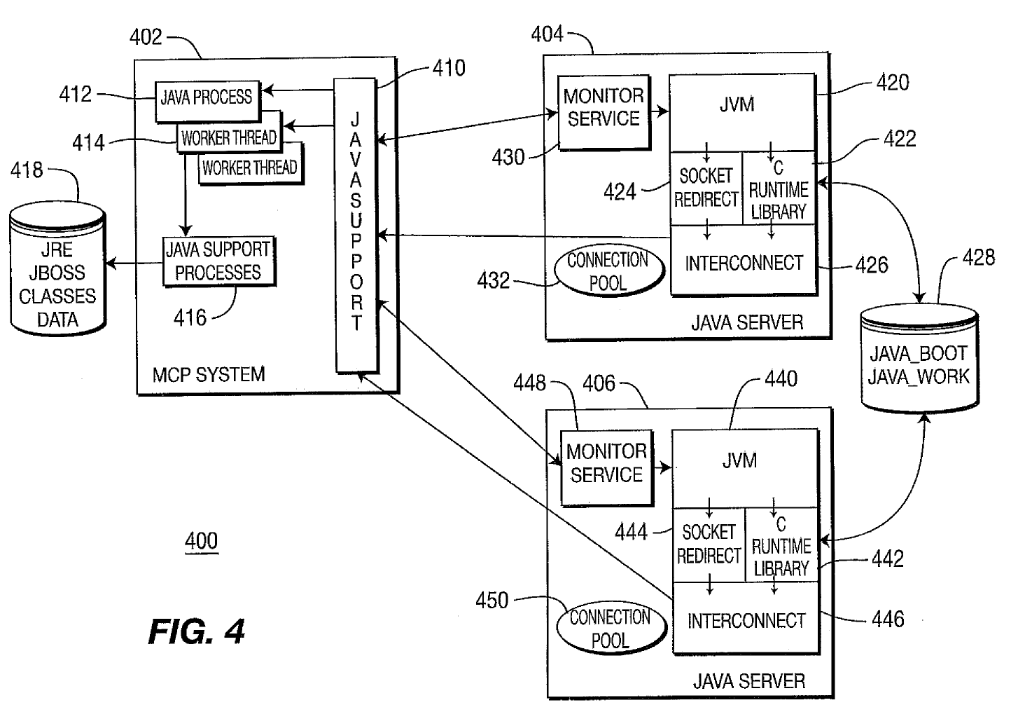

FIG. 4 is a block diagram of a system 400 including a host system 402 and multiple Java servers 404, 406. The host environment 402 shown in FIG. 4 is an MCP system. The MCP system is exemplary, and the principles of the present invention are applicable to any host environment running any operating system. Only two Java servers 404, 406 are shown in FIG. 4. The principles of the present invention are applicable to any number of Java servers, whether implemented on different processors within different physical devices or on different processors within the same physical device.

The host environment 402 includes a Java support library 410, a Java process 412, a plurality of Java worker threads 414, a plurality of Java support processes 416, and a data storage 418. The Java server 404 includes a JVM 420, a C runtime library 422, a socket redirect library 424, an interconnect library 426, a monitor service process 430, and a connection pool 432. The Java server 406 includes a JVM 440, a C runtime library 442, a socket redirect library 444, an interconnect library 446, a monitor service process 448, and a connection pool 450.

In one embodiment (shown in FIG. 4), both Java servers 404, 406 share a data storage 428 that includes the JAVA_BOOT and JAVA_WORK directories. In an alternate embodiment, each Java server 404, 406 has its own data storage 428. In another alternate embodiment, both Java servers 404, 406 share a first data storage containing the JAVA_BOOT directory, and each Java server 404, 406 has a separate second data storage for the JAVA_WORK directory. The system 400 operates in the same manner, regardless of the data storage configuration for the Java servers.

The multiple Java servers 404, 406 are used to provide performance and availability benefits over having a single Java server. When a Java program is started, an algorithm is used by the Java support library 410 to determine which Java server 404, 406 is to be used. The algorithm may use one or more methods to assign the Java servers 404, 406: round-robin, least-busy (a form of load balancing), user-assigned, and lowest numbered server available.

The Java support library 410 maintains a list of available Java servers 404, 406. When the Java process 412 calls an initiate function, the Java support library 410 assigns a Java server 404, 406 to handle the program. The Java support library 410 identifies each JVM by a combination of a process identifier (PID) from the Java server 104 of the JVM 130 and a process number from the host environment 102 (when using MCP as the host environment, this is referred to as a MIX number) of the Java process 112. Multiple concurrent executions of the Java process 412 are identified by this pair of numbers. The Java support library 410 retrieves relevant environment information for the job. The Java support library 410 creates a message containing the initiate request, job parameters, socket number, and environment information. This message is sent to the Java monitor service 430, 448 in the selected Java server 404, 406.

The Java monitor service 430, 448 receives the initiate message from the Java support library 410 and deciphers the message, translating data as necessary. It builds an environment block from the environment information in the message. It creates a process to start the JVM 420, 440, passing the job parameters as the command line and the environment block.

Multiprocessor Host Environment

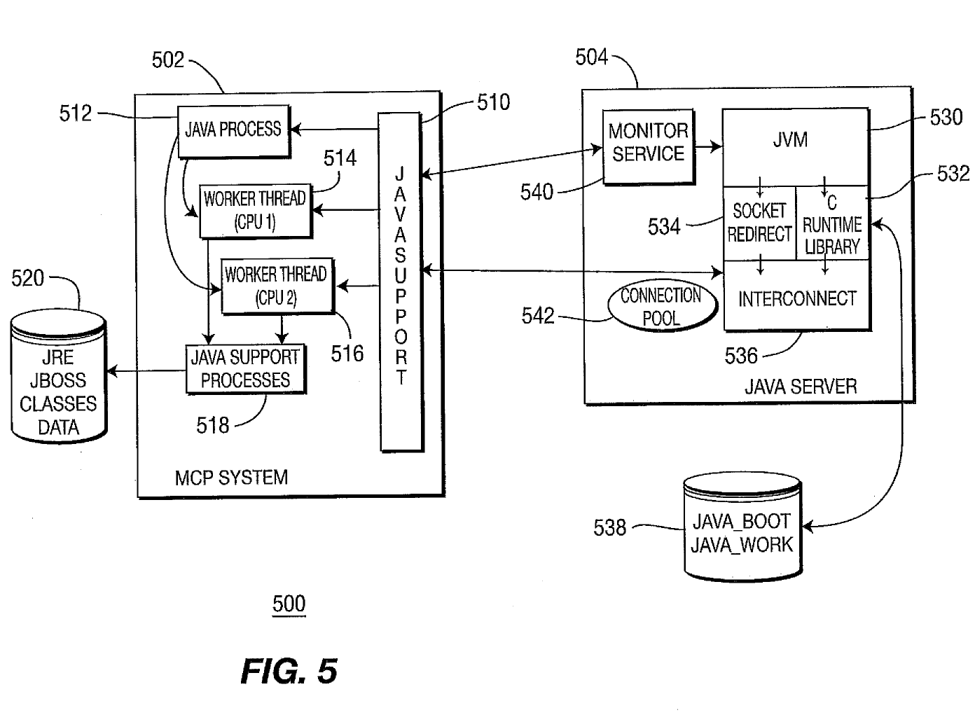

FIG. 5 is a block diagram of a system 500 in which the host environment 502 has multiple processors and interacts with a Java server 504. The host environment 502 shown in FIG. 5 is an MCP system. The MCP system is exemplary, and the principles of the present invention are applicable to any host environment running any operating system. The system 500 may also include multiple Java servers (as shown in FIG. 4, for example) and the principles of the present invention are applicable to a system 500 including any number of Java servers.

The host environment 502 includes a Java support library 510, a Java process 512, a first Java worker thread 514 running on a first CPU, a second Java worker thread 516 running on a second CPU, a plurality of Java support processes 518, and a data storage 520. The Java server 504 includes a JVM 530, a C runtime library 532, a socket redirect library 534, an interconnect library 536, a data storage 538 including the JAVA_BOOT and JAVA_WORK directories, a monitor service process 540, and a connection pool 542.

When the Java process 512 invokes a worker thread 514, 516, it can assign the worker thread to any available CPU. Each worker thread 514, 516 can run on a separate CPU; while the host environment 502 is shown with two worker threads on two CPUs, the concept is extendable to any number of worker threads running on any number of CPUs.

A benefit of having each worker thread 514, 516 run on a different CPU is increased performance of the overall system 500. For example, when a worker thread is assigned to open a socket, that thread has to listen to the socket and cannot be performing any other functions. If multiple sockets are opened, there must be a corresponding number of worker threads running. Since for at least some of the time that a socket is open, there will be nothing for the thread to listen to, other processors can be available for use by other threads without affecting an idle socket and worker thread.

It is noted that the present invention may be implemented in a variety of systems and that the various techniques described herein may be implemented in hardware or software, or a combination of both. Although the features and elements of the present invention are described in the preferred embodiments in particular combinations, each feature or element can be used alone (without the other features and elements of the preferred embodiments) or in various combinations with or without other features and elements of the present invention. While specific embodiments of the present invention have been shown and described, many modifications and variations could be made by one skilled in the art without departing from the scope of the invention. The above description serves to illustrate and not limit the particular invention in any way.

What is claimed is:

1. A method for utilizing multiple servers, comprising the steps of:
selecting a program on a host environment to be run on one of a plurality of servers;
selecting one of the plurality of servers on which to run the program;
instantiating a virtual machine on the selected server; and
running the program on the virtual machine on the selected server.

2. The method according to claim 1, wherein each of the plurality of servers is a Java server and the virtual machine is a Java virtual machine.

3. The method according to claim 1, wherein the selecting a server is performed by a support library on the host environment.

4. The method according to claim 3, wherein the support library uses a round-robin algorithm to select one of the plurality of servers.

5. The method according to claim 3, wherein the support library uses a least-used server algorithm to select one of the plurality of servers.

6. The method according to claim 3, wherein the support library uses a user preference to select one of the plurality of servers.

7. The method according to claim 3, wherein the support library selects an available server having a lowest identification number.

8. A system for utilizing multiple servers, comprising:
a host environment, comprising:
a control process; and
a support library in communication with the control process; and
a plurality of servers, each server comprising:
a virtual machine in communication with the support library; and
a monitor service in communication with the virtual machine and the support library;
wherein the support library is configured to select one of the plurality of servers to run a program on the virtual machine.

9. The system according to claim 8, wherein each of the plurality of servers is a Java server and the virtual machine is a Java virtual machine.

10. The system according to claim 8, wherein the support library uses a round-robin algorithm to select one of the plurality of servers.

11. The system according to claim 8, wherein the support library uses a least-used server algorithm to select one of the plurality of servers.

12. The system according to claim 8, wherein the support library uses a user preference to select one of the plurality of servers.

13. The system according to claim 8, wherein the support library selects an available server having a lowest identification number.

14. A method for utilizing multiple processors, comprising:
initializing a virtual machine on a server;
running a program on the virtual machine based on a request from a host environment;
sending one or more task requests from the program running on the virtual machine to a control process on the host environment; and
initializing a worker thread on the host environment for each task request, each worker thread assigned by the control process to run on a different processor on the host environment.

15. A system for utilizing multiple processors, comprising:
a host environment, comprising:
a support library;
a control process in communication with the support library;
a plurality of processors, each processor in communication with the control process; and
a server, comprising:
a virtual machine in communication with the support library; and
a monitor service in communication with the virtual machine and the support library;
wherein the virtual machine is configured to issue a request to the host environment, the support library is configured to receive the request and to forward the request to the control process, and the control process is configured to select one of the plurality of processors to handle the request.
